(19) United States
(12) Patent Application Publication
(10) Pub. No.: US 2004/0191542 A1
(43) Pub. Date: Sep. 30, 2004

(54) Thermal barrier for managing heat transfer

(76) Inventors: David Gray McLeod, Rochester, MI (US); Eric Lee, Rochester Hills, MI (US)

Correspondence Address: Richard W. Hoffmann, PO Box 70098, Rochester Hills, MI, 48307, US

(21) Appl. No.: 10/395,370

(22) Filed: Mar. 24, 2003

(51) Int. Cl. B32B 3/10; B32B 15/08

(52) U.S. Cl. 428/461; 428/137

(57) ABSTRACT

A thermal barrier providing an enclosure for a vehicle battery is provided. The thermal barrier comprises a base and at least one sidewall extending from said base. A top is disposed adjacent said sidewalls. The thermal barrier further comprises a heat dissipating layer. The heat dissipating layer may include an enthalpic associated with at least one of the base, the sidewall and the top wherein said enthalpic layer undergoes a phase transformation in response to the application of heat to said enthalpic layer. In addition to the enthalpic layer, the heat dissipating layer may include a low emissivity layer in one or more the base, sidewall and top. The heat dissipating layer may also include a conductive layer or an air gap. Additionally vents may be included in any one of the base, sidewalls and top.

### FIELD OF THE INVENTION

The present invention relates to a thermal barrier for managing heat transfer. More specifically, the present invention relates to a thermal barrier for managing heat transfer that is particularly well adapted for use as a battery enclosure in a vehicle.

### BACKGROUND OF THE INVENTION

Normal under the hood temperatures for vehicles operated in North America typically range between 62° and 82° centigrade. These temperatures in warmer climates or seasonally throughout various locations can reach in excess of 130° C. The electrolyte in the battery should be kept under 52° C. or the battery may sustain damage. Elevated temperatures applied to the batteries result in damaged batteries and, in turn, high warranty claims for the original equipment manufacturer or the need for the owner to replace the battery prior to its normal useful life. In addition to being placed under the hood, automobile batteries are now additional placed under the floor pan. Under the floor pan, batteries experience similar temperature exposures to those under the hood. Under the floor pan, batteries are typically located near the exhaust system of the vehicle. This is necessitated because the fuel system typically consumes a large amount of space on the opposite side of the vehicle.

The under the floor pan batteries have areas exposed to higher temperatures and may be referred to as the hot side of the battery. The hot side of the battery commonly is that closest to the exhaust system and closest to the front of the vehicle. The side opposite the exhaust system and the base or bottom of the battery are typically exposed to relatively lower temperature. This may be referred to as the cool side of the battery.

Currently, solutions to shielding the battery from the external heat from under the hood or under the floor pan include either wrapping the battery or providing a plastic heat shield about the battery. These insulative wraps or heat shields add cost and complexity to the assembly process and, in many instances, do not offer adequate protection from the heat source.

### SUMMARY OF THE INVENTION

According to one embodiment of the present invention there is provided a thermal barrier comprising a polymeric base and at least one polymeric sidewall. The thermal barrier further comprises a heat dissipating layer associated with at least one of the base and the sidewall.

According to another embodiment of the present invention, there is provided a thermal barrier providing an enclosure for a vehicle battery comprising a base and at least one sidewall extending from the base. A top is disposed adjacent at least one of the sidewalls. The thermal barrier further comprises a heat dissipating layer associated with at least one of the base, sidewall and top.

### BRIEF DESCRIPTION OF THE DRAWINGS

The present invention will become more fully understood from the detailed description and the accompanying drawings, wherein:

FIG. 1 is a plan view of the underside of a vehicle;

FIG. 2 is a cross sectional view of an embodiment of the present invention;

FIG. 3 is a cross sectional view of an embodiment of the present invention;

FIG. 4 is a cross sectional view of an alternate embodiment of the present invention;

FIG. 5 is a cross sectional view of an alternate embodiment of the present invention; and

FIG. 6 is an elevational view of the embodiment shown in FIG. 5.

### DETAILED DESCRIPTION OF THE PREFERRED EMBODIMENTS

The following description of the preferred embodiment(s) is merely exemplary in nature and is in no way intended to limit the invention, its application, or uses.

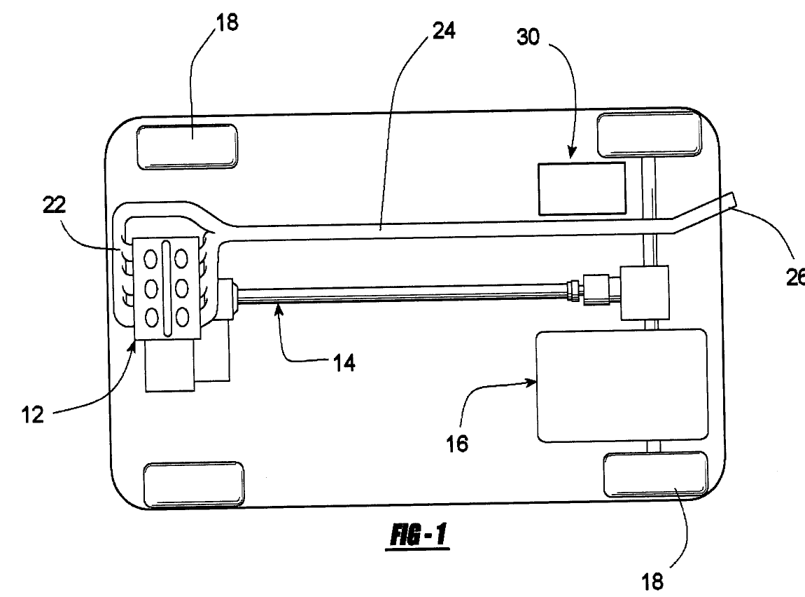

FIG. 1 shows a plan view of the bottom of a vehicle. Shown are an engine, generally indicated at 12; a drive train, generally indicated at 14; a fuel tank assembly, generally indicated at 16; and tires 18. An exhaust assembly is generally indicated at 20 that includes a manifold area 22, connected to exhaust pipe 24. The exhaust pipe terminates with tail pipe 26. The exhaust assembly 20 runs from the engine 12 under the entire length of the vehicle to the tail pipe 26. It is common that the exhaust assembly 20 be placed on one side of the vehicle and that the fuel tank assembly 16 and fuel delivery system (not shown) be placed on the other side of the vehicle. Commonly, the fuel tank assembly 16 and exhaust assembly 20 are separated by the drive train 14.

The fuel tank assembly 16 and remainder of the fuel delivery system (not shown) typically take up a relatively large area under the vehicle. Accordingly, under the floor pan, batteries are often mounted on the side of the vehicle adjacent the exhaust pipe 24. A thermal barrier comprising a battery enclosure is generally shown schematically at 30 in FIG. 1. The thermal barrier battery enclosure is shown near the rear of the vehicle. Often the battery is required to be located relatively forward on the vehicle as compared to that shown in FIG. 1. It will be understood that the thermal barrier or battery enclosure 30 can be placed at any location in the vehicle. In addition to under the floor pan, the thermal barrier 30 can be used in connection with an under the hood battery.

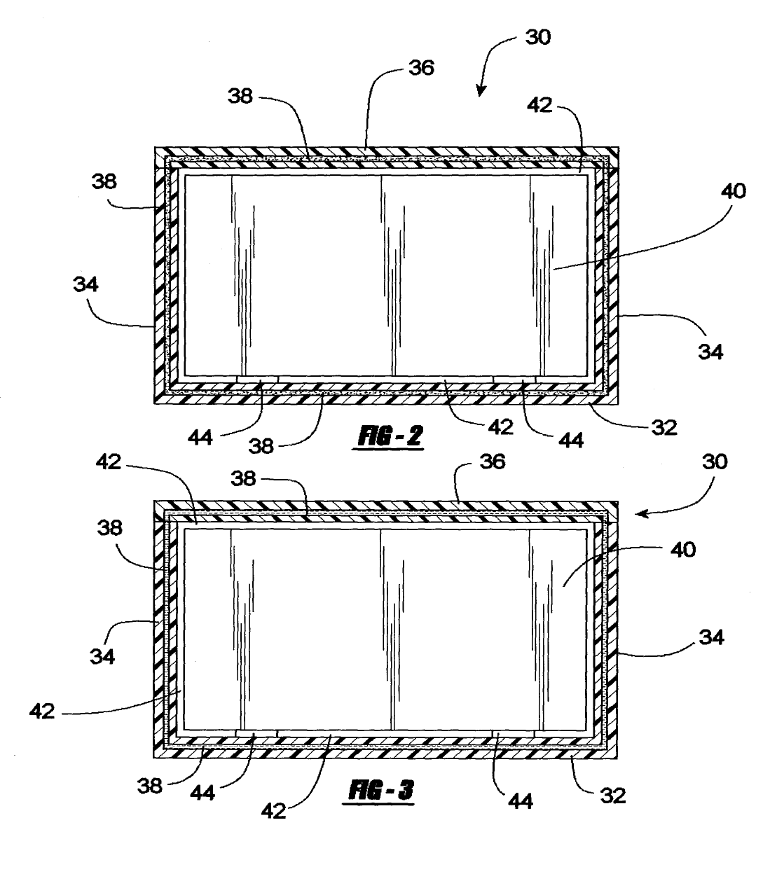

FIG. 2 shows, one embodiment of a thermal barrier 30 for managing heat transfer. Specifically, FIG. 2 shows a cross sectional view of a thermal barrier 30. The thermal barrier 30 is particularly well suited for functioning as a battery closure for under the floor pan batteries as well as batteries that are located under the hood of vehicles.

The thermal barrier 30 comprises at least a base 32 and one sidewall 34. More preferably, the thermal barrier 30 provides a complete enclosure for a battery 40. Thus, the thermal barrier 30 preferably comprises a base 32, four sidewalls 34 extending upwardly from the base 32, and a top 36. The top 36 is openable so that access can be given to the interior of the thermal barrier 30. Alternatively, one of the sidewalls 34 may be openable to give access to the interior of the thermal barrier 30. It will also be appreciated that while the thermal barrier 30 is shown to be substantially rectangular, the thermal barrier 30 can take any configuration, such as round or oval. In such a case, a single sidewall 34 having a round or oval cross section is used. Thus, any number of sidewalls 34 can be used within the scope of the present invention.

It will be understood that at least one of the base 32, sidewalls 34 and top 36 may include an opening (not shown) therethrough for allowing electrical cables to pass into the thermal barrier 30. These openings preferably include a seal between the opening and cable to limit the amount of heat transfer at the opening.

Preferably, the base 32, sidewalls 34 and top 36 each comprise a polymeric material. Most preferably, the polymeric material comprises polypropylene. Additionally, the polypropylene may contain fibers, such as glass, polymer, or carbon fibers, or fillers such as minerals or silicates of any shape, size or aspect ratio. Additionally, the polymer part may contain a metal mesh, fabric, or screen that is used to impart enhanced impact properties, to modify thermal conductivity, to add Radio Frequency shielding to the barrier, and to maintain the location of the battery following a severe crash situation by acting as a “safety net”. It will be appreciated, however, that any suitable thermoplast or thermoset polymeric material, or composite may be used to form the base 32, sidewalls 34 and top 36. The material and thickness of each of the base 32, sidewalls 34 and top 36 are selected based on the anticipated external heat and the functional requirements. The materials and thickness are chosen to minimize the thermal conductivity and manage the specific heat.

Additionally, a non-metallic light colored or white filler material may be added to the polymer for reflection of the radiant heat. The use of light colored or white non-metallic filler material (imparting a light color or white color) also will impart conduction to the polymer that, in itself, is a natural insulator. This non-metallic white coloring filler material may be a fibrous, porous or hollow organic or inorganic material that will decrease or maintain the thermal conductivity of the polymer material. The filler material may be of any shape, size or aspect ratio. Preferably, the non-metallic white filler material comprises white carbonaceous earth or zeolite particles.

In addition to the polymeric material, one or more of the base 32, sidewalls 34 and top 36 may include an enthalpic layer 38. The enthalpic layer 38 contains materials that undergo a phase change within a relevant temperature range causing some of the heat external to the thermal barrier 30 to be used as heat of fusion rather than being transferred through the thermal barrier 30 toward the battery 40. As temperatures adjacent the battery, particularly those on the hot side, may reach as high as 130° C., due, for example, to the placement of the under the battery 40 and surrounding thermal barrier 30 adjacent the exhaust pipe 24 in a vehicle, it is desirable to use a enthalpic layer 38 that includes materials having phase changes in the range of about 104° C. to 131° C.

Preferably the enthalpic layer 38 contains at least one material selected from the group comprising a linear low-density polyethylene (LLDP), medium density polyethylene (MDPE) and high-density polyethylene (HDPE). Most preferably, the enthalpic layer 38 contains a combination or mixture of LLDP, MDPE, and HDPE, which have melting ranges from 104° C. to 131° C. More specifically, and as shown in FIG. 2, the enthalpic layer 38 is shown in solid form. As heat is applied to the exterior of the thermal barrier 30, as the heat is transferred toward the battery, the solid enthalpic layer 38 undergoes a phase transformation from solid, as shown in FIG. 2, to liquid as shown in FIG. 3. The heats of transformation cause an increase of the materials in the enthalpic layer's 38 specific heat before and during the melting phase. It will be appreciated that, as long as appropriate crystalline materials are chosen for the enthalpic layer 38 for the required temperatures, no oxidation should occur.

The enthalpic layer 38 is shown as a distinct layer in each of the base 32, sidewalls 34 and top 36. However, the material that make up the enthalpic layer may be dispersed throughout the polymeric material that comprises the base 32, sidewalls 34 and top 36. Further, it will be appreciated that the material for the enthalpic layer 38 can be chosen to have a melting temperature different from that described above. The materials can be selected to tailor the melting temperatures to the anticipated temperatures to be encountered in the area surrounding the battery 40.

The amount of material used to form the enthalpic layer 38, or the amount dispersed throughout the polymeric material helps delay heat transfer to the battery 40 over the relevant temperature ranges by using materials, and preferably combinations of materials with various melting points over the applicable temperature range.

As shown in FIGS. 2 and 3, the enthalpic layer 38 is shown in each of the base 32, sidewalls 34 and top 36. In certain instances, it may be desirable to only have the enthalpic layer to be in selected of the base 32, sidewall 34 and top 36. It is preferable that the enthalpic layer be in those areas of the thermal barrier 30 that are on the hot side of the battery.

As shown in FIGS. 2 and 3, an air gap 42 is interposed between the base 32, sidewalls 34, top 36, and battery 40. The air gap 42 provides an insulative layer between the polymer material and the battery 40. The air gap 42 helps retard heat transfer from outside of the thermal barrier 30 to the battery 40. It will be appreciated that more than one air gap can be provided in any one of the sidewalls 34, base 32 and top 36. This can be accomplished simply by molding air spaces into the structures.

One or more battery supports 44 may be connected to the base 32. The battery supports 44 maintain the battery 40 in a position that is elevated relative to the base 32. This allows the air gap 42 to also be located under the battery 40 adjacent the base 32.

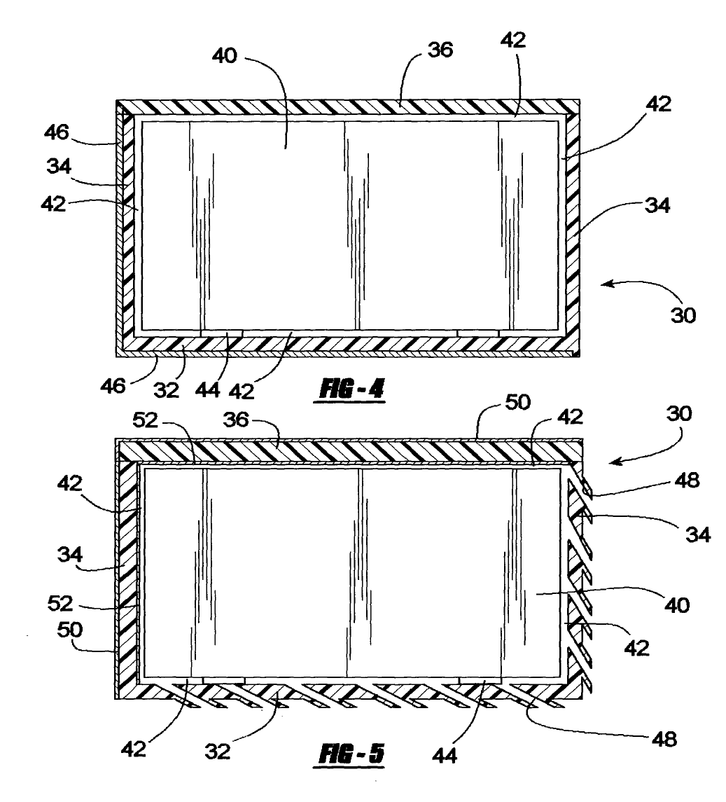

FIG. 4 is cross sectional view showing an alternate embodiment of the present invention. The FIG. 4 embodiment includes a base 32, sidewalls 34, and top 36. One or more of the base 32, sidewalls 34, and top 36 may include the enthalpic layer 38 discussed above. As shown, the base 32 and one sidewall 34 includes a conductive layer 46 that may be insert molded into the base 32 or sidewall 34. The conductive layer 46 allows for a high rate of heat dissipation to the environment. Such a conductive layer is preferably placed on the side of the thermal barrier 30 that is opposite the heat source, that is, on the cool side of the battery. Thus, for the positioning of the thermal barrier depicted in FIG. 1, the sidewall 34 opposite the tail pipe 24 and the base 32 are on the cool side of the battery and may include the conductive material. In this manner, any heat that passes through into the interior of the thermal barrier 30 from the hot side of the battery can be quickly dissipated on the cooler side through the conductive material by way of thermal conduction.

The conductive material may comprise any suitably conductive material. In general, metals tend to provide suitably conductive material. It is preferred that the material comprises a copper metal mesh. The copper metal mesh allows for a high rate of heat dissipation from the interior of the thermal barrier 30. The metal mesh also is used to help retain the battery 40 in the event of impact to the vehicle, which may otherwise cause fracture to the thermal barrier 30 and battery 40. The metal mesh may extend to the outside surface of the sidewall 34 or base 32. Alternatively, the metal mesh may be wholly contained within either the sidewall 34 or base 32.

It will also be appreciated that the conductive layer 46 may be found in any one of the base 32, sidewalls 34 or top 36. Additionally, the conductive layer 46 may be included in only a portion of one or more of the base 32, sidewalls 34, and top 36.

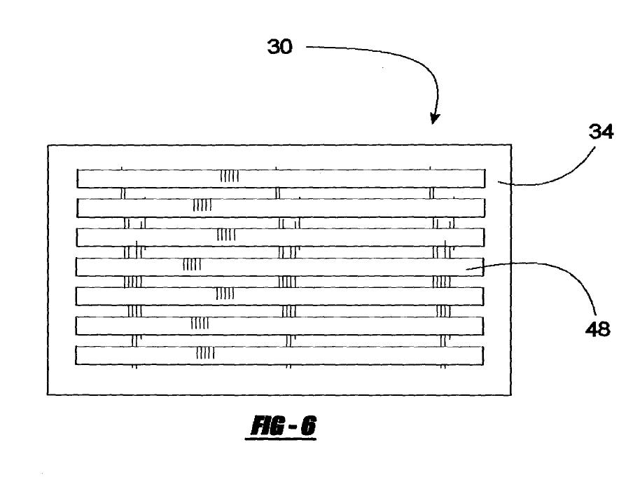

FIG. 5 shows an alternate embodiment of the present invention. FIG. 5 shows the use of vents 48 in the base 32 and sidewall 34. The vents 48 provide an opening between the atmosphere and the air gap 42. Preferably, the vents 48 are located on the cool side of the battery. The vents 48 allow for conduction cooling. That is, heat that enters the thermal barrier 30 from the hot side of the battery can be conducted through the vents 48 to the atmosphere. This results in a relatively higher rate of dissipation of the heat from the battery 40.

It will be appreciated that the vents may take any configuration. As shown in FIGS. 5 and 6, the vents 48 are shown as openings covered by the polymeric material. In this manner the vents 48 have a louvered appearance. Because the openings defining the vents 48 are covered in a louver type fashion, debris is limited from entering the interior of the thermal barrier 30. However, the vents 48 can simply be openings directly through the polymeric material. Additionally, the vents 48 can be openings that define labyrinths through the polymeric material to help limit debris from entering the interior of the thermal barrier 30.

FIG. 5 also shows the use of a low emissivity layer 50. The low emissivity layer 50 preferably is disposed on the exterior of any base 32, sidewall 34, or top 36 that is on or adjacent the hot side of the battery. The emissivity layer 50 is disposed adjacent the polymeric material making up either the base 32, sidewalls 34, or top 36. Preferably, the low emissivity layer 50 has an emissivity value that is lower than that of the polymer making up either the base 32, sidewalls 34, or top 36 to which it is attached. For example, materials such as aluminum have an emissivity of 0.02 and are suitable for use as the low emissivity layer 50. The emissivity of standard black polymer enclosures currently used is close to 1.0. It will be appreciated that the low emissivity layer 50 may comprise any suitable material that has an emissivity value lower than that of the material used to make the base 32, sidewalls 34, or top 36.

The low emissivity layer 52 is shown as a separate and distinct layer on the polymeric material that makes up the base 32, sidewalls 34 and top 36. However, the emissivity layer 52 can be dispersed in the polymeric material. One such example is the disperse aluminum flake into the polymeric material.

Additionally, FIG. 5 shows a thermal reflective layer 52 in the interior of the thermal barrier adjacent the sidewalls 34 and top 36. The thermal reflective layer 52 is a second low emissivity layer that is located in the air gap 42. It will be appreciated that the thermal reflective layer 52 can be adjacent any one of the base 32, sidewalls 34, or top 36. The thermal reflective layer 52 is secured to associated base, 32, sidewall 34 or top 36.

Preferably, the thermal reflective barrier is adjacent only the components of the base 32, sidewalls 34 or top that are on or adjacent the hot side of the battery. An example of the thermal reflective layer is the use of a sheet of aluminized polymer film (vacuum metallized polyester).

Both of the low emissivity layer 50 and thermal reflective layer 52 are used to reduce the transfer of radiant energy across the air gap 42. This reduces the amount of heat transferred from a point external to thermal barrier 30 to the battery 40.

Each of the above methods of limiting heat from entering the interior of the thermal barrier 30 on the hot side of the battery, and dissipating from the interior of the thermal barrier 30 on the cool side of the battery can be used alone, or in combination. The result to be achieved is to slow the rate of heat transfer on the hot side of battery to the interior of the thermal barrier 30, and to flash any heat out of the interior or the thermal barrier 30 on the cool side of the battery.

Each of the enthalpic layer 38, light colored or white filler, low emissivity layer 50, thermal reflective layer 52, air gap 42 and conductive layer 46 provide heat dissipating layers. That is, each either limits heat flow into thermal barrier 30 or removes heat from the thermal barrier 30. Preferably, the enthalpic layer 38, light colored or white filler, low emissivity layer 50 and thermal reflective layer 52 are disposed at least on the hot side of the battery. Each of these heat dissipating layers limit heat flow into the thermal barrier 30. Additionally, it is preferred that the conductive layer 46 and vents 48 be located at least on the cool side of the battery. The conductive layer 46 and vents 48 dissipate the heat by removing in from the thermal barrier 30. The air gap also provides a heat dissipating layer by limiting heat transfer to the battery.

As stated above each of these heat dissipating layers can be used either alone or in combination with the other layers. Each of the heat dissipating layers is associated with one of the base 32, sidewall 34 or top 36 of the thermal barrier. In order to be associated with one of the base 32, sidewall 34 or top 36, the heat dissipating layer can be either adjacent or disposed in one of the base 32, sidewall 34 or top 36. Additionally to be associated with one of the base 32, sidewall 34 or top 36, the heat dissipating layer can be adjacent or disposed in another heat dissipating layer that is associated with the base 32, sidewall 34 or top 36.Thus, as shown in FIG. 5, the low emissivity layer 50, thermal reflective layer 52 and air gap 42 are each associated with the base 32 and sidewall 34. This allows for the sequential use of the heat dissipating layers adjacent the base 32, sidewall 34 or top 36.

While in the preferred embodiments the thermal barrier 30 completely encases the battery 40, it will be appreciated that a complete enclosure may not be necessary in certain applications. One or more of the base 32, sidewall 34 or top 36 may be used within the scope of the present invention. For example, it may only be necessary to utilize a base 32 and two sidewalls 34 located on the hot side of the battery. In this case the thermal barrier 30 limits heat transfer to three sides of the battery 40 while the remaining portion of the battery is exposed to the atmosphere. Any combination of base 32, sidewalls 34 or top 36 may be used within the scope of the present invention.

The foregoing embodiments allow for integrated thermal management for an enclosure about a battery. The thermal barrier 30 is durable and can either be used alone, or in combination with pre-existing methods of shielding the batter from heat.

The invention has been described in an illustrative manner and it is to be understood that the terminology that has been used is intended to be in the nature of words of description rather than of limitation. Many modifications and variations are possible in light of the above teaching. It is, therefore, to be understood that within the scope of the appended claims, the invention may be practiced other than as specifically described.

What is claimed is:

1. A thermal barrier comprising:
a polymeric base;
at least one polymeric side wall; and
a heat dissipating layer associated with at least one of said base and said sidewall.

2. A thermal barrier as set forth in claim 1 wherein said heat dissipating layer comprises and enthalpic layer wherein said enthalpic layer undergoes a phase transformation in response to the application of heat thereto.

3. A thermal barrier as set forth in claim 2 wherein said enthalpic layer includes at least one material selected from the group comprising, low linear density polyethylene, medium density polyethylene and high density polyethylene.

4. A thermal barrier as set forth in claim 2 wherein said enthalpic layer includes a mixture of material selected from the group comprising, low linear density polyethylene, medium density polyethylene and high density polyethylene.

5. A thermal barrier as set forth in claim 1 wherein said heat dissipating layer comprises a low emissivity layer associated with at least one of said sidewall and said base.

6. A thermal barrier as set forth in claim 5 wherein said low emissivity layer comprises aluminum.

7. A thermal barrier as set forth in claim 6 wherein said low emissivity layer comprises an aluminized polymer film.

8. A thermal barrier as set forth in claim 1 wherein said heat dissipating layer comprising a conductive layer associated with at least one of said sidewall and said base.

9. A thermal barrier as set forth in claim 8 wherein said conductive layer comprises copper metal mesh.

10. A thermal barrier as set forth in claim 1 wherein said heat dissipating layer comprises a filler associated at least one of said polymeric base and said polymeric sidewall, said filler selected from the group comprising light colored and white particulate, fibrous, porous and hollow organic and inorganic materials.

11. A thermal barrier as set forth in claim 10 wherein said filler is selected from the group comprising white carbonaceous earth and zeolite particles.

12. A thermal barrier as set forth in claim 1 wherein said heat dissipating layer comprises an air gap associated with one of said sidewall and said base.

13. A thermal barrier as set forth in claim 12 further comprising vents in at least one of said sidewalls and said base.

14. A thermal barrier providing an enclosure for a vehicle battery comprising:
a base;
at least one sidewall extending from said base;
a top adjacent said at least one of sidewalls; and
a heat dissipating layer associated with at least one of said base, said sidewall and said top.

15. A thermal barrier as set forth in claim 13 wherein said heat dissipating layer includes an enthalpic layer and wherein said enthalpic layer undergoes a phase transformation in response to the application of heat thereto.

16. A thermal barrier as set forth in claim 15 wherein said enthalpic layer comprises at least one material selected from the group comprising, low linear density polyethylene, medium density polyethylene and high density polyethylene

17. A thermal barrier as set forth in claim 15 wherein said enthalpic layer includes a mixture of material selected from the group comprising, low linear density polyethylene, medium density polyethylene and high density polyethylene.

18. A thermal barrier as set forth in claim 14 wherein said heat dissipating layer further comprises a low emissivity layer associated with at least one of said sidewall, said base and said top.

19. A thermal barrier as set forth in claim 18 wherein said low emissivity layer comprises aluminum.

20. A thermal barrier as set forth in claim 19 wherein said low emissivity layer comprises an aluminized polymer film.

21. A thermal barrier as set forth in claim 14 wherein said heat dissipating layer further comprises a conductive layer associated with at least one of said sidewall, said base and said top.

22. A thermal barrier as set forth in claim 21 wherein said conductive layer comprises copper metal mesh.

23. A thermal barrier as set forth in claim 14 wherein said sidewall, said base and said top comprise a polymeric material.

24. A thermal barrier as set forth in claim 23 wherein said heat dissipating layer further comprises a filler in at least one of said polymeric base and said polymeric sidewall, said filler selected from the group comprising light colored and white particulate, fibrous, porous and hollow organic and inorganic materials.

25. A thermal barrier as set forth in claim 24 wherein said filler is selected from the group comprising white carbonaceous earth and zeolite particles.

26. A thermal barrier as set forth in claim 14 wherein said heat dissipating layer further comprises an air gap associated with at least one of said sidewall, said base and said top and said battery.

27. A thermal barrier as set forth in claim 26 further comprising vents in at least one of said sidewalls, said base and said top.

28. A thermal barrier as set forth in claim 14 wherein said sidewall, said base and said top define a cavity therein for receiving a battery.
